(19) United States
(12) Patent Application Publication
(10) Pub. No.: US 2008/0189122 A1
(43) Pub. Date: Aug. 7, 2008

(54) COMPETITIVE FRIEND RANKING FOR COMPUTERIZED SOCIAL NETWORKING

(76) Inventors: Candice L. Coletrane, Durham, NC (US); Robyn A. McGlotten, Durham, NC (US); William G. Pagan, Durham, NC (US); Wilson Velez, Raleigh, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/670,805

(22) Filed: Feb. 2, 2007

(51) Int. Cl. G06Q 99/00

(52) U.S. Cl. 705/1

(57) ABSTRACT

Embodiments of the invention address deficiencies of the art in respect to favorite friends in a computerized social network and provide a method, system and computer program product for competitive favorite friend ranking for social networking services In one embodiment of the invention, a competitive friend ranking method can be provided. The method can include monitoring interactions between different friends and a profile in a social network. The method also can include ranking each of the different friends according to the monitored interactions. Thereafter the method can include adjusting a display of at least a portion of the different friends in the profile in order of most highly ranked friends.

### BACKGROUND OF THE INVENTION

1. Field of the Invention

The present invention relates to the field of computerized social networking and more particularly to friend ranking in a computerized social network.

2. Description of the Related Art

A social network refers to a social structure of nodes each associated with a different person or organization. The interconnections of each node reflect direct relationships between the respective people and organizations such that the directness of a relationship between two persons or organizations associated with respective nodes can be summarized by the path of interconnections between the respective nodes. In this way, any one individual in a social network can evaluate the number and quality of social relationships with others in the network, those relationships ranging from close familial bonds to casual acquaintances.

The advent of the global Internet has changed the way in which social networks can be viewed. Originally, a mere visual tool describing a social phenomenon, computerized social networks facilitate the recognition and expansion of social networks amongst interacting users across the globe. Whereas geographic boundaries previously limited the extent and quality of a given social network, the global Internet enables limitless expansion of the social network based upon a vast set of aware collaborators coupled by the fabric of computer communications.

Commercial computerized social networks have become wildly popular in recent years—especially amongst the younger demographic. Examples include the MySpace™ computer socialized network maintained by MySpace, Inc. of Los Angeles, Calif., LinkedIn™ computerized business network maintained by LinkedIn Corporation of Palo Alto, Calif., and the Facebook™ computerized social network maintained by Facebook of Palo Alto, Calif. Commercial computerized social networks represent social networking services connecting users according to different types of interests in an aggregated view—generally a Web site hosting Web log (also known as blog) type services. Generally, commercial computerized social networks generate revenue through ad placements in the Web site.

Generally, commercial computerized social networks allow users to create individual profiles. Each profile can include visual materials such as photographs of the user and things relevant to the user. Each profile further can include textual materials such as lifestyle information, or general writings. Notably, users can establish networks of favorite “friends”. Favorite friends can be specified manually by a given user and often represent the individuals or organizations most favored by the given user. Each of the favorite friends can be presented in the Web site so as to allow linking to a corresponding profile for the favorite friend. In this way, an end user literally can navigate the social network for a given user.

### BRIEF SUMMARY OF THE INVENTION

Embodiments of the invention address deficiencies of the art in respect to favorite friends in a computerized social network and provide a novel and non-obvious method, system and computer program product for competitive favorite friend ranking for social networking services In one embodiment of the invention, a competitive friend ranking method can be provided. The method can include monitoring interactions between different friends and a profile in a social network. The method also can include ranking each of the different friends according to the monitored interactions. Thereafter the method can include adjusting a display of at least a portion of the different friends in the profile in order of most highly ranked friends.

In one aspect of the embodiment, monitoring interactions between different friends and a profile in a social network can include monitoring several different types of interactions. Those interaction can include by way of example, a frequency of a friend messaging a user for a profile, a frequency of a friend commenting on content in a profile, a frequency of a friend visiting a profile, a frequency of a friend linking to external content associated with a user for a profile, a frequency of a friend reading blog material in a profile, a frequency of the friend posting content onto a profile, when a friend responds to a message from a user for a profile, when a friend adds a user for a profile to a friend list, and when a friend lists similar or identical interests to the interests listed in a profile. In another aspect of the embodiment, ranking each of the different friends according to the monitored interactions can include applying a score to the different friends for correspondingly different monitored interactions. Finally, in yet another aspect of the embodiment, ranking each of the different friends according to the monitored interactions further can include weighting different scores to emphasize some of the interactions over others of the interactions.

In another embodiment of the invention, a social networking system configured for competitive friend ranking can be provided. The system can include a data store of profiles, each of the profiles including a friend list of friends displaying the friends in rank order. The system also can include a social networking service coupled to the data store of profiles and a friend ranking engine. The friend ranking engine can include program code enabled to rank the friends in the friend list according to monitored interactions for each profile for interacting ones of the friends. Optionally, each of the friends can include a score computed from the monitored interactions, each of the monitored interactions contributing to the score. Also, each contribution to the score can be weighted according to a type of interaction.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a computerized social network configured for competitive friend ranking;

FIG. 2 is a schematic illustration of computerized social network configured for competitive friend ranking; and,

FIG. 3 is a flow chart illustrating a process for competitive friend ranking in the computerized social network of FIG. 2.

### DETAILED DESCRIPTION OF THE INVENTION

Embodiments of the invention provide a method, system and computer program product for competitive friend ranking in a computerized social network. In accordance with an embodiment of the present invention, the friends of a user in a social network can be ranked according to the behavior of each of the friends in interacting with the profile of the user. Criteria used in ranking the behavior of friends of a user can include a frequency of the friend messaging the user, a frequency of the friend commenting on content in the profile of the user, a frequency of the friend visiting the profile of the user, a frequency of the friend linking to external content associated with the user, a frequency of the friend reading blog material associated with the user, a frequency of the friend posting content onto the profile of the user, responding to a message from the user, adding the user to a friend list, and listing similar or identical interests to the interests listed in the profile of the user, to name only a few examples.

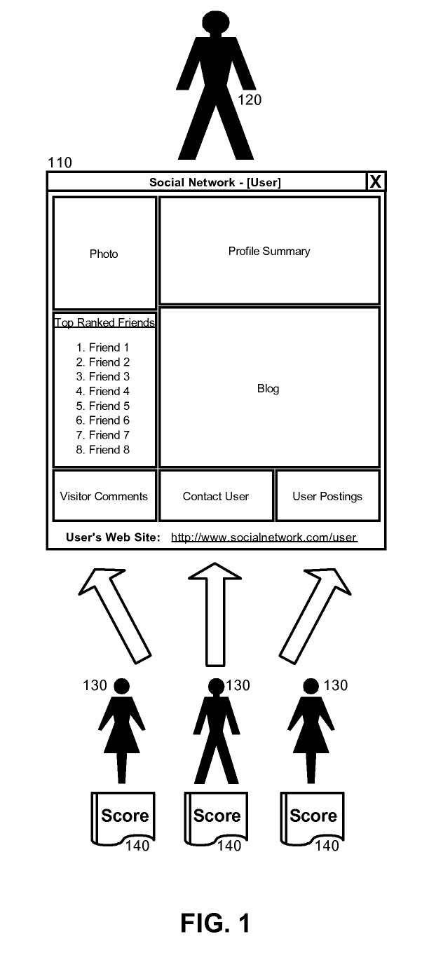

In illustration, FIG. 1 is a pictorial illustration of a computerized social network configured for competitive friend ranking. As shown in FIG. 1, a user 120 in a social network can post a profile 110 for viewing by other users 130 of the social network. The profile 110 can include a photographic image of the user 120 and a profile summary of the user such as an age, location and basic interests. The profile further can include a blog portion into which the user 120 can post blog entries for subscribing ones of the other users 130. A control panel through which the user 120 can be contacted further can be provided, including e-mail and instant messaging controls. Notably, a ranked listing of friends portion of the profile 110 can be provided. Finally, respective portions for positing visitor comments and user comments can be provided along with a hyperlink to a Web site for the user 120.

Notably, interactions between different ones of the other users 130 and the profile 110 can be monitored. Different types of interactions can form the basis of a score 140 recorded in association with a corresponding one of the other users 130. In this regard, each of the other users 130 can be scored according to a frequency of messaging the user 120, a frequency of posting a comment to the profile 110, a frequency of visiting the profile 110, a frequency of linking to external Web site from the profile 110, a frequency of reading blog material associated with the user 120, a frequency of posting content onto the profile 110, when responding to a message from the user 120, when adding the user 120 to a friend list, and listing similar or identical interests to the interests listed in the profile summary of the profile 110, to name only a few examples.

The score 140 for each of the other users 130 can be used to rank the other users 130 when included in a friend list in the profile 110. Specifically, the placement and ordering of a top few friends in the profile 110 can be determined according to a total score applied to each of the friends. As such, achieving a placement in the friend list of the profile 110 can be competitive in nature and can depend upon the interactions of the friends with the profile 110 as reflected in a corresponding one of the scores 140. In consequence, friends most likely to view advertising placed in proximity to the profile 110 will be known to the advertiser driving upwards the advertising value of the profile 110, itself.

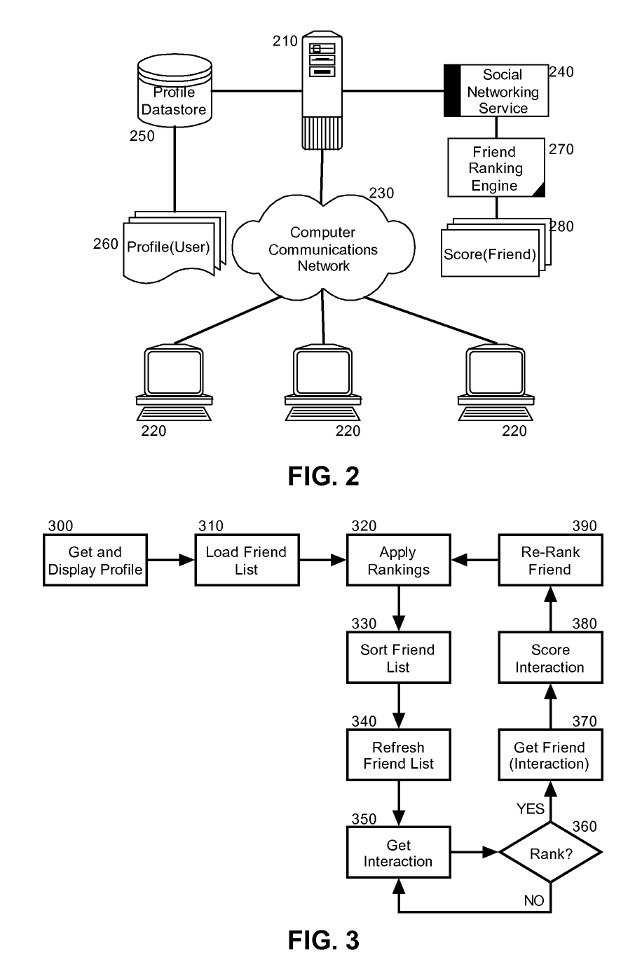

In further illustration, FIG. 2 is a schematic illustration of computerized social network configured for competitive friend ranking. The system can include a host computing platform 210 configured for communicative coupling to one or more clients 220 over a computer communications network 230. The host computing platform 210 can support the operation of a social networking service 240 providing views to one or more user profiles 260 disposed within a coupled profile data store 250. In this way, end users can search for and select a view to any of the given profiles 260 remotely from over the computer communications network 230.

Notably, a friend ranking engine 270 can be coupled to the social networking service 240. The friend ranking engine 270 can include program code enabled to apply different scores 280 to different friends of different ones of the profiles 260. The scores 280 can be computed according to any number of monitored interactions between individual ones of the friends and individual ones of the profiles 260. The interactions can include, by way of example, a frequency of the friend messaging a user for a profile, a frequency of the friend commenting on content in a profile, a frequency of the friend visiting a profile, a frequency of the friend linking to external content associated with a user for a profile, a frequency of the friend reading blog material in a profile, a frequency of the friend posting content onto a profile, when a friend responds to a message from a user for a profile, when a friend adds a user for a profile to a friend list, and when a friend lists similar or identical interests to the interests listed in a profile. Optionally, any one of the scoring criteria can be weighted to favor a given set of scoring criteria over other criteria.

The program code of the friend ranking engine 270 also can be enabled to sort a set of friends for a given one of the profiles 260 according to a score for each corresponding one of the friends in the set. Thereafter, the highest ranked friends can be displayed prominently in the given one of the profiles 260. The display of the competitively ranked friends can change fluidly as scores 280 are accumulated for the friends for each of the profiles 260. In this way, different friends can be incentivized to continuously interact with different ones of the profiles 260 in order to achieve or maintain a ranking in the friend lists for the different ones of the profiles 260.

In yet further illustration, FIG. 3 is a flow chart illustrating a process for competitive friend ranking in the computerized social network of FIG. 2. Beginning in block 300, a profile for a social networking service can be retrieved and displayed for viewing by one or more users of the social networking service. In block 310, a friend list for the profile can be loaded and in block 320, rankings can be applied to the different friends in the friend list. In block 330, the friends in the friend list can be sorted according to ranking and in block 340, the display of the friend list can be refreshed to provide a sorted, ranked view of the friends in the friend list.

In block 350, interactions between different friends of the profile and the profile itself can be monitored. In decision block 360, it can be decided whether a given interaction is sufficient to score a corresponding friend. If so, block 370 a friend associated with the interaction can be retrieved for processing and in block 380, the interaction can be scored. The scoring can determined based upon a static table of values or based upon a pre-stored formula, and optionally can be weighted. Thereafter, the friend can be re-ranked 390 according to the new score. Finally, the rankings can be re-applied to the friends in the friend list in block 320 and the process can repeat through block 330.

The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A competitive friend ranking method comprising:
monitoring interactions between different friends and a profile in a social network;
ranking each of the different friends according to the monitored interactions; and,
adjusting a display of at least a portion of the different friends in the profile in order of most highly ranked friends.

2. The method of claim 1, wherein monitoring interactions between different friends and a profile in a social network, comprises monitoring interactions selected from the group consisting of a frequency of a friend messaging a user for a profile, a frequency of a friend commenting on content in a profile, a frequency of a friend visiting a profile, a frequency of a friend linking to external content associated with a user for a profile, a frequency of a friend reading blog material in a profile, a frequency of the friend posting content onto a profile, when a friend responds to a message from a user for a profile, when a friend adds a user for a profile to a friend list, and when a friend lists similar or identical interests to the interests listed in a profile.

3. The method of claim 1, wherein ranking each of the different friends according to the monitored interactions, comprises applying a score to the different friends for correspondingly different monitored interactions.

4. The method of claim 3, wherein ranking each of the different friends according to the monitored interactions, further comprises weighting different scores to emphasize some of the interactions over others of the interactions.

5. A social networking system configured for competitive friend ranking, the system comprising:
a data store of profiles, each of the profiles comprising a friend list of friends displaying the friends in rank order;
a social networking service coupled to the data store of profiles; and,
a friend ranking engine comprising program code enabled to rank the friends in the friend list according to monitored interactions for each profile for interacting ones of the friends.

6. The system of claim 5, wherein the monitored interactions comprises interactions selected from the group consisting of a frequency of a friend messaging a user for a profile, a frequency of a friend commenting on content in a profile, a frequency of a friend visiting a profile, a frequency of a friend linking to external content associated with a user for a profile, a frequency of a friend reading blog material in a profile, a frequency of the friend posting content onto a profile, when a friend responds to a message from a user for a profile, when a friend adds a user for a profile to a friend list, and when a friend lists similar or identical interests to the interests listed in a profile.

7. The system of claim 5, wherein each of the friends comprises a score computed from the monitored interactions, each of the monitored interactions contributing to the score.

8. The system of claim 7, wherein each contribution to the score is weighted according to a type of interaction.

9. A computer program product comprising a computer usable medium embodying computer usable program code for competitive friend ranking, the computer program product comprising:
computer usable program code for monitoring interactions between different friends and a profile in a social network;
computer usable program code for ranking each of the different friends according to the monitored interactions; and,
computer usable program code for adjusting a display of at least a portion of the different friends in the profile in order of most highly ranked friends.

10. The computer program product of claim 9, wherein the computer usable program code for monitoring interactions between different friends and a profile in a social network, comprises computer usable program code for monitoring interactions selected from the group consisting of a frequency of a friend messaging a user for a profile, a frequency of a friend commenting on content in a profile, a frequency of a friend visiting a profile, a frequency of a friend linking to external content associated with a user for a profile, a frequency of a friend reading blog material in a profile, a frequency of the friend posting content onto a profile, when a friend responds to a message from a user for a profile, when a friend adds a user for a profile to a friend list, and when a friend lists similar or identical interests to the interests listed in a profile.

11. The computer program product of claim 9, wherein the computer usable program code for ranking each of the different friends according to the monitored interactions, comprises computer usable program code for applying a score to the different friends for correspondingly different monitored interactions.

12. The computer program product of claim 11, wherein the computer usable program code for ranking each of the different friends according to the monitored interactions, further comprises computer usable program code for weighting different scores to emphasize some of the interactions over others of the interactions.
